(19) United States
(12) Patent Application Publication
(10) Pub. No.: US 2018/0281229 A1
(43) Pub. Date: Oct. 4, 2018

(54) APPARATUS FOR DISTRIBUTING AGGREGATE MATERIAL

(71) Applicants: Donald Denis CRAWLEY, Brighton, Sussex (GB); Glasseco LLC, Miami, FL (US)

(72) Inventor: Donald Denis Crawley, Brighton (GB)

(21) Appl. No.: 15/780,868

(22) PCT Filed: Dec. 2, 2016
(86) PCT No.: PCT/GB2016/053801

§ 371 Date: Jun. 1, 2018

(30) Foreign Application Priority Data
Dec. 2, 2015 (GB) 1521235.0

(51) Int. Cl. B28B 13/02

(52) U.S. Cl. CPC B28B 13/029; B65G 69/0425

(57) ABSTRACT

Certain embodiments of the present invention relate to an apparatus for distributing aggregate material at a target location. Also included in certain embodiments of the present invention is a method for distributing aggregate material at a target location. Certain embodiments of the present invention may be used in the manufacture of an apparatus that provides a surface, e.g. a panel. In particular, but not exclusively, certain embodiments of the present invention relate, at least in part, to a method of manufacturing an apparatus which comprises a resin component and at least one aggregate material.

### TECHNICAL FIELD

Certain embodiments of the present invention relate to an apparatus for distributing aggregate material at a target location. Also included in certain embodiments of the present invention is a method for distributing aggregate material at a target location. Certain embodiments of the present invention may be used in the manufacture of an apparatus that provides a surface, e.g. a panel. In particular, but not exclusively, certain embodiments of the present invention relate, at least in part, to a method of manufacturing an apparatus which comprises a resin component and at least one aggregate material. The methods and apparatus disclosed herein are used to manufacture apparatus for example countertops e.g. for use in kitchens, worktops, desktops, bathroom furniture such as sinks and shower trays, as well as flooring surfaces and the like. Further embodiments of the present invention relate to an apparatus for carrying out the method and for producing a surface apparatus e.g. a countertop as described herein.

### BACKGROUND TO THE INVENTION

The use of resin and aggregate components is commonplace to form a wide variety of composites which provide hard-wearing surfaces. For example, resin-bonded aggregate material is used to produce paving and flooring. In addition, surfaces such as countertops e.g. for use in kitchens, worktops and desktops are often manufactured from a resin-aggregate composite material. The apparatus is hard wearing, low maintenance and has a high scratch/impact resistance. A large range of aggregate components may be used, depending on the intended use and/or the desired look of the apparatus. For example, glass chips, marble chips, concrete, granite and the like have all been used to form surface apparatus such as floors, desktops and countertops.

Terrazzo surfacing is one example of a surfacing apparatus which includes a binder and an aggregate component. Terrazzo is a composite material which is poured in place or into a mold and is typically used as flooring, work surfaces and wall surfaces. Terrazzo surfaces are characterized by exposed marble or other aggregate chips or pieces set in a cementitious, polymer or resin matrix. Terrazzo can be highly decorative with different coloured aggregate being used to form the flooring or other surface type to form a custom-made surface. Custom surfaces can be made using different types of fill and aggregate and metal dividers and can depict different patterns or scenes such as landscapes.

A variety of different binders or resins can be used in the preparation of terrazzo flooring or panels. Some prior art surfacing methods use cement based resin as a binder. Other methods use epoxy resins which are considered to be advantageous since they are available in a wide variety of colours, cure faster thus allowing faster installation, offer increased strength and durability and are generally impermeable unlike cement based resins.

U.S. Pat. No. 6,770,328 discloses a prior art method of making a terrazzo surface from recycled glass. The method disclosed in U.S. Pat. No. 6,770,328 involves mixing together crushed recycled glass, epoxy resin and epoxy primer and then applying a layer of the mixture to a floor surface or mold. The mixture is then spread using a trowel and cured. Following curing, the surface is then smoothed by grinding. An epoxy grout is then applied to the surface to fill air bubbles that are present on the top surface following grinding. The method of U.S. Pat. No. 6,770,328 describes mixing the aggregate, resin and curing agent in a single step. In addition, the method does not include vibrating the mixture.

Prior art methods of producing resin-aggregate composite apparatus can be labour-intensive and result in the inclusion of air bubbles in the resulting surface. The air bubbles can result in weakness in the apparatus. In addition, air inclusions allow bacteria to cultivate in the pores and also retain dirt. This can be unhygienic especially if the surface is used in kitchens for example. The look of the apparatus can also be spoilt by retention of dirt in the air inclusions. In addition, prior art methods often have the disadvantage of uneven spread of aggregate material in the resin which is aesthetically undesirable.

### Summary of Certain Embodiments of the Invention

It is an aim of certain embodiments of the present invention to at least partly mitigate the above-mentioned problems associated with the prior art.

It is an aim of certain embodiments of the present invention to provide an apparatus for uniformly distributing aggregate material at a target surface. Prior art methods often result in uneven distribution of aggregate material which is not desirable particularly if the method is for use to distribute aggregate for inclusion in surface apparatus such as worktops and the like.

Certain embodiments of the present invention aim to avoid overfilling of aggregate at a central area of a target location and under-filling of aggregate at a peripheral area of a target location.

Certain embodiments of the present invention comprise methods which result in resin-aggregate composite apparatus which comprise a reduced number of air inclusions therein. Particularly, certain embodiments of the present invention comprise the application of a vacuum to a mold in which resin and aggregate are located. In addition, certain embodiments of the present invention provide a method which results in less wear on the tooling equipment used to produce the surface apparatus described herein. Certain embodiments of the present invention aim to overcome problems associated with prior art methods which pre-mix aggregate and resin. Particularly, pre-mixing requires cleaning of the vessels and tools used which requires more labour and involves less accurate weighing and volume measurements.

In a first aspect of the present invention, there is provided an apparatus for distributing aggregate material at a target location comprising:
a) an aggregate release device for selectively releasing aggregate material from a storage region;
b) a first plurality of deflecting blade members orientated in a first orientation;
c) a further plurality of deflection blade members orientated in a further direction; wherein each deflecting blade member comprises a respective deflection surface that deflects falling aggregate that impacts the deflection surface in an at least partially transverse direction.

Aptly, the apparatus further comprises at least one first deflecting member comprising the first plurality of deflecting blade members; and at least one further deflection member comprising the further plurality of deflecting blade members. In certain embodiments the first and further plurality of deflecting blade members each comprise a respective plurality of elongate blade members disposed in a spaced apart substantially parallel relationship. Aptly, the deflection surface comprises a tapered upper surface of the deflecting blade member. Aptly, the deflection surface comprises a tapered lower surface of the deflecting blade member.

Aptly, the first and further plurality of deflecting blade members are disposed in a vertically spaced apart substantially parallel relationship. Aptly, the first plurality of deflecting blade members is disposed in a generally perpendicular relationship to the further plurality of deflecting blade members. Aptly, the first and further deflection blade members are maintained in a spaced apart relationship by one or more spacing elements.

In certain embodiments, the further plurality of deflecting blade members is a second plurality of deflecting blade members and the apparatus further comprises a third plurality of deflecting blade members disposed in a vertically spaced apart substantially parallel relationship to the first plurality of deflecting blade members and the second plurality of deflecting blade members, wherein each deflecting blade member comprises a respective deflection surface that deflects falling aggregate that impacts the deflection surface in an at least partially transverse direction.

Aptly, the third plurality of deflecting blade members is disposed beneath the second plurality of deflecting blade members. Aptly each blade member of the third plurality of deflecting blade members is substantially parallel to a respective blade member of the first plurality of deflecting blade members. In certain embodiments each blade member of the third plurality of deflecting blade members is disposed at a respective third blade location and each blade member of the first plurality of deflecting is disposed at a respective first blade location, wherein each of the first locations is at least partially offset respective to a respective third location.

Aptly, each of the first locations is at least partially offset in a transverse direction with respective to a respective one of the third locations.

Aptly, the apparatus further comprises a fourth plurality of deflecting blade members disposed in a vertically spaced apart substantially parallel relationship to the first plurality of deflecting blade members, the second plurality of deflecting blade members and the third plurality of deflecting blade members, wherein each deflecting blade member of the fourth plurality of deflecting blade members comprises a respective deflection surface that deflects falling aggregate that impacts the deflection surface in an at least partially transverse direction.

Aptly, the fourth plurality of deflecting blade members is disposed beneath the third plurality of deflecting blades. In certain embodiments, each deflecting blade member of the fourth plurality of deflecting blade members is substantially parallel to a respective blade member of the second plurality of deflecting blade members. In certain embodiments, each deflecting blade member of the fourth plurality of deflecting blade members is disposed at a respective fourth blade location and each deflecting blade member of the second plurality of deflecting is disposed at a respective first blade location, wherein the second and fourth locations are at least partially offset.

In certain embodiments, each of the second locations is at least partially offset in a transverse direction with respective to a respective one of the fourth locations. In certain embodiments, the apparatus further comprises a tapered section disposed at a lower portion thereof.

Aptly, the apparatus further comprises at least one mesh layer disposed beneath the first and further plurality of deflecting blade members. Aptly, the at least one mesh layer comprises a plurality of spaced apart, substantially parallel, mesh layers each comprising a plurality of openings wherein openings in a mesh layer are offset with respect to openings in an adjacent mesh layer.

Aptly, the apparatus is adapted to comprise a substantially fluid-tight seal such that a negative pressure may be applied thereto. Aptly the apparatus comprises a lid element disposed on an upper portion thereof. In certain embodiments, the lid element comprises sealing means for sealing the housing to enable negative pressure to be applied to the apparatus. Aptly, the lid element further comprises one or more handles. Aptly, the apparatus comprises a inlet for connection to a negative pressure source.

Aptly, the target location is disposed in an enclosure, wherein in use the enclosure is disposed beneath the apparatus.

Aptly, the apparatus is adapted for a sealing attachment to the enclosure, wherein said sealing attachment enables a negative pressure to be applied to the enclosure.

Aptly, the aggregate release device comprises a plurality of panels, wherein each panel is selectively rotatable about a respective longitudinal axis from a closed position in which edges of adjacent panels at least partially overlap, to an open position in which edges of the panels are spaced apart to allow the aggregate material to be released. Aptly, in the open position, the panels are rotated to locate a region of an upper surface of each panel at least partially in a pathway of aggregate material falling from the container. In one embodiment, the apparatus comprises a storage region for storing the aggregate material prior to release. Aptly, the storage region is disposed above the aggregate release device.

In certain embodiments, the apparatus further comprises a tensioning element for tensioning at least one mesh layer. In certain embodiments, the tensioning element is adapted to rigidly secure the at least one mesh layer to a deflecting blade member of a lowermost plurality of deflecting blade members.

Aptly, the apparatus comprises at least one motor for vibrating the first and further plurality of deflecting blade members. Aptly the apparatus comprises a motor for vibrating the at least one mesh layer. The motor for vibrating the at least one mesh layer may be the same as the motor for vibrating the first and further plurality of deflecting blades or it may be a separate motor. Aptly, the motors are connected to one or more electronic or phase invertors to change the frequency and/or force as required.

In one embodiment, the apparatus further comprises at least one further support for supporting the enclosure. Aptly, the at least one further support comprises at least one transfer element. Aptly, the at least one transfer element comprises a roller.

In one embodiment, the at least one further support comprises at least one securing element for releasably securing the enclosure to an upper surface of the support. Aptly, the at least one securing element comprises a vacuum clamp. Aptly, the at least one further support comprises a motor for vibrating the support.

In a further aspect of the present invention, there is provided apparatus for distributing aggregate material at a target location comprising:
a) an aggregate release device for selectively releasing aggregate material from a storage region;
b) a first plurality of deflecting blade members orientated in a first orientation;
c) a further plurality of deflecting blade members orientated in a further direction; wherein each deflecting blade member comprises a respective deflection surface that deflects falling aggregate that impacts the deflection surface in an at least partially transverse direction;
wherein the apparatus comprises at least one sealing element for forming a substantially fluid-tight seal around at least one perimeter of the apparatus such that negative pressure can be applied to an area within the apparatus.

Aptly, the apparatus further comprises an inlet for supplying negative pressure to an interior of the apparatus. Aptly, the apparatus further comprises at least one element for providing a substantially fluid-tight seal between the apparatus and an enclosure disposed adjacent to the apparatus. Aptly, the apparatus further comprises a lid element, wherein the inlet is provided in the lid element. Aptly, the apparatus is adapted to supply negative pressure to an enclosure when in a substantially fluid tight relationship with the enclosure. The sealing element may be for example a grooved portion in an upper and/or lower surface edge of the apparatus in combination with an O-ring seal.

Aptly, applying a vacuum keeps air from the bottom surface of an enclosure into which the aggregate is being dispersed. As a result, there are fewer air inclusions in the top surface of a resin-aggregate panel (the surface adjacent to the base of the mold becomes the top surface of the formed panel). In addition, there is a reduced requirement for post-curing filling of imperfections in the surface of the panel.

In a further aspect of the present invention there is provided a method of distributing aggregate material at a target location comprising re-directing a vertical downwards falling motion of at least a portion of aggregate material via a plurality of deflecting blade members.

Aptly, the method comprises releasing aggregate material from a storage location and directing the aggregate material to a first plurality of deflecting blade members. Aptly, the method further comprises directing the aggregate material to a further plurality of deflecting blade members such that the vertical downwards falling motion of at least a portion of the aggregate material is redirected in an at least partially transverse pathway.

In a further aspect of the present invention, there is provided a method of forming a surface apparatus comprising;
providing an apparatus according to certain embodiments as described herein; locating an enclosure containing a resin component and a curing agent below a lower end of the apparatus; and
releasing aggregate material substantially simultaneously from a storage location in a generally downward falling motion within the apparatus; and distributing the aggregate material in the enclosure.

In one embodiment, the method comprises, prior to locating the enclosure below the apparatus, a step of mixing the resin component and the curing agent together to form an activated resin component prior to pouring into the enclosure. Aptly, the aggregate material is added to the enclosure separately and subsequent to the activated resin component being added. Aptly, the enclosure is vibrated in the first vibration mode for at least 1, 2, 3, 4, 5, 6, 7, 8, 9, 10 or more minutes before the aggregate material is added.

Aptly, the step of vibrating the enclosure in a further vibration mode is carried out prior to or simultaneously with the step of adding aggregate material e.g. a first aggregate material to the enclosure. Following the addition of the aggregate material, the further vibration mode agitates the resin component, curing agent and aggregate component to form a mixture. In one embodiment, the first vibration mode and the further vibration mode differ in frequency and/or amplitude. In an embodiment, the first vibration mode and the further vibration mode have substantially the same frequency and/or amplitude.

In one embodiment, the first vibration mode has a frequency of vibration of between about 20 Hz to about 42 Hz e.g. 20, 25, 30, 35, 40 or 42 Hz. In one embodiment, the first vibration mode has a frequency of vibration of about 25 Hz. In one embodiment, the method comprises applying the first vibration mode for between about 1 minute and 10 minutes e.g. about 1, 2, 3, 4, 5, 6, 7, 8, 9, or 10 minutes. Alternatively, the method comprises applying the first vibration mode for more than 10 minutes or less than one minute.

In one embodiment, the first vibration mode has an amplitude of vibration of e.g. 0.1 g, 0.2 g, 0.3 g or 0.4 g. In one embodiment, the method comprises applying the further vibration mode for between about 1 minute and 10 minutes e.g. about 1, 2, 3, 4, 5, 6, 7, 8, 9, or 10 minutes. Alternatively, the method comprises applying the further vibration mode for more than 10 minutes or less than one minute. In one embodiment, the further vibration mode has a frequency of vibration of between about 25 Hz to about 50 Hz or greater e.g. 25, 30, 35, 40, 42, 45 or 50 Hz or more. Aptly, the further vibration mode has an amplitude of vibration of from about 0.6 to 1.4 g.

Aptly, the method comprises adding further aggregate material to the enclosure, wherein optionally each subsequent aggregate material weighs less than each aggregate material previously added. That is to say, aptly, individual elements of each subsequent aggregate material weigh less on average than individual elements of each aggregate material previously added. Aptly, the method comprises adding a third aggregate material to the enclosure. Aptly, the third aggregate material is added subsequent to the first and second aggregate material. Aptly, the enclosure is vibrated prior to, during and following addition of the third aggregate material.

Aptly, the first aggregate material, the second aggregate material and further aggregate material e.g. the third aggregate material are added to the enclosure at substantially the same time. Aptly, following distribution of the first aggregate material and at least one further aggregate material to the enclosure, the enclosure is vibrated for a predetermined length of time e.g. between about 1 minutes to about 10 minutes or more.

Aptly, the method comprises positioning the enclosure containing the resin component and the curing agent below the apparatus of certain embodiments of the invention. In one embodiment, the method comprises loading a storage region of the apparatus with aggregate material.

Aptly, the method further comprises the steps of re-directing a vertical falling motion of the aggregate material(s) released from the container via at least a first and further plurality of deflecting blade members.

Aptly, the aggregate release device comprises a plurality of rotatable panels as described herein. Aptly, the apparatus is loaded with aggregate material when the panels are in a closed position. In one embodiment, the panels are rotated from the closed position to an open position to release the aggregate material from the storage region. In certain embodiments, the aggregate release device comprises a plurality of elongate parallel panels, wherein the elongate parallel panels are rotatable from an open position in which edges of the panels are spaced apart and a closed position in which edges of adjacent panel members at least partially overlap.

In one embodiment, the method further comprises the steps of comprising the steps of releasing the aggregate material substantially simultaneously by rotating the panels in common by the same angle of rotation.

Aptly, the method further comprises the steps of re-directing a vertical downwards falling motion of aggregate material released from a storage region by locating a first plurality of deflecting blade members between the storage region and the enclosure. Aptly, the method comprises the steps of re-directing a vertical downwards falling motion of aggregate material released from a storage region by locating a further plurality of deflecting blade members between the aggregate release device and the enclosure.

In one embodiment, the method further comprises the steps of re-directing a vertical falling motion of the aggregate component released from the storage region via at least one mesh layer located between the deflecting blade members and the enclosure.

In one embodiment, the method further comprises the steps of deflecting falling aggregate component(s) in a transverse direction with respect to a vertical downward direction, via struts of a lower mesh layer having openings offset with respect to openings of an adjacent mesh layer. Aptly, the method comprises vibrating the apparatus during the step of deflecting the falling aggregate component(s).

Aptly, the method comprises providing a layer of activated resin component on an upper surface of the mixture in the enclosure, wherein the mixture comprises the first aggregate component, the further e.g. the second aggregate component, the resin component and the curing agent.

Aptly, the method comprises levelling a top surface of the aggregate, resin component and curing agent mixture. In one embodiment, the method comprises vibrating the enclosure in a third vibration mode during the step of levelling.

In one embodiment, the third vibration mode has a frequency of vibration of from about 25 to about 45 Hz, e.g. 25, 30, 35, 40, 42 or 45 Hz. Aptly, the third vibration mode has a frequency of vibration of up to about 42 Hz. Aptly, the third vibration mode has an amplitude of vibration of from about 0.6 to 1.4 g.

In one embodiment, the step of applying the further vibration mode comprises encouraging air to be released from an upper surface of the resin component/curing agent/first aggregate component mixture.

Aptly, the method further comprises curing the aggregate component, resin and curing agent mixture in the enclosure mixture to form the apparatus. In one embodiment, the method comprises curing at ambient temperature e.g. at a temperature of between about 17 to 25° C. In one embodiment, the method comprises curing at a temperature of between about 10° C. to about 35° C. In one embodiment, the method comprises forming a curved apparatus and the curing is at a temperature of approximately 10° C. Aptly, the method further comprises heating and shaping the cured mixture to form the apparatus.

Aptly, the method comprises applying vibration to the enclosure. Aptly, the enclosure is positioned on a table which is capable of vibrating. Certain vibrating tables are known in the art. In one embodiment, the table is capable of varying the frequency and/or amplitude of the vibration. Aptly, the table is capable of varying the centrifugal force from e.g. about 2.48 kN to about 1.98 kN. In one embodiment, the centrifugal force is between about 1.98 kN to about 2.98 kN. Aptly the table is comprised within an assembly as described herein.

Aptly, the range of amplitude and/or frequency is determined by a user via a controller connected to the table. Aptly, a top of the table top sits on spring isolators with vibrating motors suspended from the bottom of the table top. Aptly, the motors are connected to electronic invertors and/or one or more phase inverters to change the frequency and force as required.

In a further aspect of the present invention, there is provided an assembly for manufacturing an apparatus that provides a surface and which comprises a resin component and an aggregate component, the assembly comprising an apparatus as described herein and a support for supporting an enclosure containing an activated resin component below the apparatus.

Aptly, the assembly comprises at least one motor for vibrating the apparatus and/or the support. In certain embodiments, the assembly further comprises at least one further support for supporting the enclosure. Aptly, the at least one further support comprises at least one transfer element for transferring the enclosure to the further support.

Aptly, the at least one transfer element comprises a roller. In certain embodiments, the at least one further support comprises at least one securing element for releasably securing the mold to an upper surface of the support. Aptly, the at least one securing element comprises a vacuum clamp.

Certain embodiments of the present invention provide methods which produce apparatus e.g. panels for use as worktops and the like which are less than about 15 mm in thickness. For example, the apparatus may be from about 4 to 15 mm in thickness. Also included in certain embodiments of the present invention are surface apparatus e.g. panels which are less than 15 mm in thickness.

The reduction in thickness of the apparatus may enable the apparatus to be used as a surface apparatus in a multilayer apparatus. For example, a resin-aggregate component apparatus as described herein may be provided as a top layer in a multi-layered product wherein one or more lower layers are formed from other materials. In one embodiment, there is provided a layered apparatus comprising the surface apparatus as described herein and a second layer, wherein the second layer is not the surface apparatus of the present invention. In one embodiment, the second layer may be formed from chipboard, wood or the like.

Certain embodiments of the present invention provide an apparatus for providing a surface produced by the methods disclosed herein. The apparatus may have fewer pores created by air inclusion and therefore fewer areas for bacteria to cultivate in and/or retain dirt. Certain embodiments of the present invention provide methods which can be used to produce resin-aggregate composite apparatus in a large number of different forms e.g. floor panels, shower enclosures, bath panels, countertops and worktops.

Certain embodiments of the present invention provide a method and/or an apparatus which enables surface apparatus to be produced which have a thickness of approximately 6 mm.

As used herein, the term “a resin/curing agent/aggregate material mixture” is interchangeable with the term “a mixture comprising a resin, a curing agent and aggregate material”. It will be understood that the resin component will be an activated resin component when mixed with a suitable curing agent.

Aptly, the aggregate material is distributed in an enclosure positioned beneath the apparatus of embodiments of the present invention. The enclosure is aptly a mold for forming a surface providing apparatus such as for example a panel or the like.

Aptly, the aggregate material is a first aggregate material and the method comprises distributing a further aggregate material. Aptly, the further aggregate material is distributed into the enclosure subsequent to the first aggregate material. The further aggregate material may comprise a different parameter to the first aggregate material. That is to say, the further aggregate material may comprise individual aggregate components which are on average e.g. less dense than individual aggregate components of the first aggregate material.

Aptly, the resin/curing agent mixture is a liquid. Further details of the resin component and the curing agent are provided below.

Aptly, the aggregate material is selected from glass chips, stone chips, engineered stone chips, shells, plastic chips, gold leaf and rare material chips such as rare glass chips, mirror chips and metal chips. In one embodiment, the aggregate material is a recycled material.

Aptly, the further aggregate material is selected from glass chips, stone chips, engineered stone chips, shells, plastic chips, mirror chips, metal chips, gold leaf and rare material chips such as rare glass chips. In one embodiment, the further aggregate material is a recycled material.

In a further aspect of the present invention, there is provided an apparatus for providing a surface obtainable by the method of embodiments of the present invention. Aptly, the apparatus e.g. surface apparatus comprises fewer air inclusions as compared to an apparatus obtainable from methods which comprise mixing a resin, a curing agent and an aggregate at substantially the same time.

In a further aspect of the present invention, there is provided an apparatus for providing a surface comprising an aggregate material and a cured resin component, wherein the apparatus has a thickness of less than about 10 mm.

In one embodiment, the apparatus is a panel. In one embodiment, the apparatus is one of a countertop, a worktop, a table top, a desk top, a wall panel, a shower tray, a shower screen or a floor or the like. Aptly, the panel is translucent. Aptly, the panel is curved. In one embodiment, the apparatus is a countertop or a worktop.

Aptly, the apparatus has a thickness of approximately 4mm or greater. Aptly, the apparatus comprises approximately 50% to 90% less surface air inclusions than a panel obtainable by prior art methods. Aptly, the aggregate component comprises glass chips, wherein optionally the glass chips are formed from recycled glass.

In a further aspect of the present invention there is provided a multi-layered apparatus comprising the surface-providing apparatus of certain embodiments of the present invention, wherein the surface-providing apparatus forms a first layer thereof. Aptly, the multi-layered apparatus comprises a second layer, wherein the second layer is formed from a material which differs from the first layer. In one embodiment, the second layer is formed from a material selected from wood, concrete and chipboard.

Certain embodiments of the present invention include the use of a resin component. Aptly, the resin component is a liquid resin component i.e. liquid at ambient temperature prior to being mixed with a curing agent and cured.

In one embodiment, the resin component comprises an epoxy resin. Epoxy resins contain a reactive oxirane structure which is referred to as an “epoxy” functionality. There are a large number of epoxy resins which may be suitable for use in embodiments of the present invention.

Aptly, the epoxy resin component comprises a compound selected from the group consisting of Bis phenol A, Bis phenol F, Novolac and hydrogenated Bis phenol A or derivatives thereof. Aptly, the epoxy resin comprises a bisphenol A based epoxy resin.

Aptly, the resin component is substantially solvent free. In one embodiment, the epoxy resin component is colourless. Aptly, the epoxy resin component is coloured. In one embodiment, the resin component is ketone solvent free. In one embodiment, the resin component comprises an alcohol solvent. Certain suitable epoxy resins are manufactured by the Dow Chemical Company and sold under the D.E.R trade name which covers a number of different epoxy resins.

Other suitable epoxy resins are manufactured by Momentive and sold under the trade name EPON™. In one embodiment, the epoxy resin component comprises EPON™ Resin 825, which is a high purity bisphenol A epichlorohydrin epoxy resin. In one embodiment, the epoxy resin component comprises a difunctional bisphenol A/epichlorohydrin derived liquid epoxy resin. In one embodiment, the resin component comprises EPIKOTE 240.

Aptly, the epoxy resin component comprises EPON™ Resin 8132 which is a 100% reactive low viscosity liquid bisphenol-A based epoxy resin diluted with an alkyl glycidyl ether. Aptly the epoxy resin component comprises epoxy resin UKR137.

Aptly, the resin component comprises more than one epoxy resin e.g. two or more epoxy resins. Aptly, the resin component comprises an epoxy resin e.g. an epoxy resin described herein, in an amount of between about 65 wt % and about 100 wt. %. Aptly, the resin component comprises the epoxy resin in an amount of about 65 wt. %, 70 wt. %, 75 wt. %, 80 wt. %, 85 wt. %, 90 wt. %, 95 wt. %, 96, 97, 98, 99 or 100 wt. %. Aptly, a suitable amount of resin in a resin component is determined based on desired physical properties such as viscosity, hardness and tensile strength etc.

In an embodiment, the resin component comprises a formulated blend of an epoxy resin and at least one other component. Aptly, the resin is diluted. Suitable diluents may be monofunctional or multifunctional. Aptly, the at least one other component comprises a reactive diluent. Suitable diluents may include, but are not limited to, a glycidyl ether e.g. C₁₂-C₁₄ aliphatic glycidyl ether. Reactive diluents are typically used to reduce viscosity. Aptly, the resin component comprises a resin modifier. Resin modifiers may be used to improve mechanical and thermal shock resistance, increase elongation and obtain higher impact strength and flexibility. Examples of resin modifiers include e.g. aliphatic diepoxides and monofunctional epoxide compounds.

In one embodiment, the resin component comprises a polyester resin. Aptly, the resin component comprises a polyester resin between about 75 wt. % and about 100 wt. % of a polyester resin. Aptly, the resin component comprises the polyester resin in an amount of about 65 wt. %, 70 wt. %, 75 wt. %, 80 wt. %, 85 wt. %, 90 wt. %, 95 wt. % or 100 wt. %.

In one embodiment, the resin component comprises a coloured pigment. Aptly, the resin component may comprise a filler e.g. alumina, silica, powered glass and the like.

Aptly, the resin component comprises a UV stabiliser. In one embodiment, the resin component comprises a bactericide e.g. a bactericide produced by SteriTouch®

Aptly, the resin component comprises a silane. Aptly, the resin component comprises a defoamer. Suitable defoamers are supplied by BYK Chemie. The defoamer may comprise silicone.

In one embodiment, the method comprises the use of a curing agent. As used herein, the term “curing agent” may be interchanged with the term “hardener” or “activator”. The type of curing agent used in the invention will depend upon the type of resin used. Aptly, the curing agent is a liquid at ambient temperature. In one embodiment, the curing agent is a paste at ambient temperature.

Aptly, the curing agent is an amine and is for use as a hardener of an epoxy resin. In one embodiment, the curing agent comprises at least one of a primary amine, a modified primary amine, an aliphatic, a cycloaliphatic, an anhydride, or combinations thereof. Aptly, the curing agent is an amine e.g. a polyamine e.g. an aliphatic polyamine. In one embodiment, the curing agent is a modified aliphatic amine. In one embodiment, the curing agent is a cycloaliphatic polyamine.

In one embodiment, the curing agent comprises an aliphatic amine compound e.g. diethylene triamine, triethylene tetramine and/or tetraethylene pentamine. Aptly, the curing agent may comprise an aromatic amine e.g. metaphenylene diamine and/or diamino diphenyl sulfone.

In one embodiment, the curing agent is an agent selected from a group of agents marketed under the trade name Polypox and manufactured by the Dow Chemical Company. Other suitable curing agents are produced by the Dow Chemical company for example curing agents sold under the trade names D.E.H.™ e.g. D.E.H. 20, D.E.H. 24, D.E.H. 26 and D.E.H. 29. Further suitable curing agents are sold by Momentive under the trade name EPIKURE™. Further suitable curing agents include the agent sold under the trade name UKH 136.

Aptly, the curing agent comprises an anhydride. Aptly, the curing agent comprises an anhydride and an accelerator e.g. a tertiary amine. Aptly, the curing agent comprises nadic methyl anhydride (NMA). In one embodiment, the curing agent comprises a polyamide. Aptly, when the method comprises the use of a polyester resin, the curing agent is an organic peroxide.

The method of certain embodiments of the present invention comprises the use of an enclosure into which the components are added. The enclosure acts as a mold or casting block and its dimensions dictate the dimensions of the resultant surface apparatus e.g. a panel. The resultant panel may be subject to further modification, e.g. heating, to further shape it into a desired form or surface modification.

Aptly, the inner surface of the enclosure is polished to ease removal of the apparatus once cured. In one embodiment, the enclosure is manufactured from melamine faced MDF. Alternatively, the enclosure is manufactured from polished steel, stainless surface, glass, HDPE, rubber and/or silicone. Aptly, the enclosure comprises an easy release plastic surface as an inner surface. Aptly, the inner surface is treated with a release agent. Aptly, the release agent is a PVA release agent. In one embodiment, the release agent is a wax.

Aptly, the enclosure has dimensions which correspond to the desired dimensions of an apparatus to be manufactured. In one embodiment, the enclosure has a substantially rectangular base panel. Alternatively, the enclosure may comprise for example a circular base panel, a square base panel, a triangular base panel or other suitable shaped base panels.

Aptly, the enclosure comprises a base which has dimensions of approximately 1000 mm×3000 mm. Aptly, the enclosure comprises a base which has dimensions of approximately 1220 mm×3050 mm.

Aptly, the aggregate material comprises individual aggregate elements (e.g. a glass chip) which have an average cross section of between about 2 mm to about 80 mm. In one embodiment, the aggregate material has an average cross section of approximately 2 mm, 3 mm, 5 mm, 10 mm, 15 mm, 20 mm, 25 mm, 30 mm, 35 mm, 40 mm, 45 mm, 50 mm, 55 mm, 60 mm, 65 mm, 70 mm, 75 mm, 80 mm or greater. In one embodiment, the aggregate material comprises individual aggregate elements which have a cross section of 15 mm or greater. In one embodiment, the aggregate material comprises individual aggregate elements which have a cross section of 15 mm or less. In one embodiment, the aggregate material comprises individual aggregate elements which have a cross section of between about 8 mm and about 15 mm.

In one embodiment, the aggregate material comprises individual aggregate elements which are cubes approximately 2×12×12 mm in dimension. That is to say, in one embodiment, the individual aggregate elements comprise a cuboid-like shape. Aptly, an individual aggregate element of the aggregate material weighs 3 grams or more e.g. 3, 4, 5, 6, 7, 8, 9, or 10 g. In one embodiment, the individual aggregate element of the aggregate material weighs approximately 4 g.

In one embodiment, the aggregate material comprises individual aggregate elements which have a cross section of 15 mm or less. Aptly, the aggregate material comprises individual aggregate elements which have a cross section of 8 mm or less. Aptly, the aggregate material comprises individual aggregate elements which have a cross section of 1.5 mm or less. Aptly, the aggregate material comprises individual aggregate elements which weigh less than 4 g e.g. 3 g, 2 g, 1 g, 0.5 g, 0.3 g, 0.2 g or less.

In one embodiment, the aggregate material comprises individual aggregate elements which have a cross section of 15 mm or less. Aptly, the aggregate material comprises individual aggregate elements which have a cross section of 8 mm or less. Aptly, the aggregate material comprises individual aggregate elements which have a cross section of 1.5 mm or less. Aptly, the aggregate material comprises individual aggregate elements which have a cross section of less than about 0.5 mm. Aptly, the aggregate material weighs less than 4 g e.g. 3 g, 2 g, 1 g, 0.5 g, 0.3 g, 0.2 g or less.

In one embodiment, a portion of the aggregate material is a recycled material. The recycled material may be (a) pre-consumer recycled material, (b) post-consumer recycled material or a mixture of (a) and (b).

The aggregate material may be sourced from any suitable source e.g. waste material from the automotive industry, construction industry, hospitality industry, consumer sources and recycling cooperatives or the like.

Aptly, the aggregate material used to form the apparatus of the present invention each independently comprise at least 30% recycled material, e.g. 35%, 40%, 45%, 50%, 55%, 60%, 65%, 70%, 75%, 80%, 85%, 90% or greater.

In one embodiment, the aggregate material comprises a bead mixture. Aptly, the bead mixture comprises at least one of polymeric beads, glass beads, cork beads, sand beads, or combinations thereof. Aptly, the bead mixture comprises non-uniformly sized beads.

The aggregate material may comprise individual aggregate elements which differ in colour so as to form a multi-coloured apparatus. Alternatively or in addition the second and/or further aggregate components may differ in colour and texture to the first aggregate component thus adding to the decorative nature of the apparatus formed.

The surface apparatus of the present invention can take a desired shape and size. The shape and size of the apparatus will depend on the shape and size of the enclosure. The enclosure may have a substantially flat bottom internal surface. In this embodiment, the apparatus will comprise a substantially flat surface. Alternatively, the enclosure may have an undulating lower internal surface, whereby the resultant apparatus will have a correspondingly undulating surface.

In one embodiment, the apparatus provides a surface. In one embodiment, the apparatus is a panel. In one embodiment, the apparatus is substantially rectangular. The apparatus may be for use in a domestic setting e.g. as a countertop. Aptly, the apparatus is a kitchen counter top.

In one embodiment, the method further comprises, following curing, heating the panel to bend the apparatus into a desired shape. Thus, the panel which is removed from the mold may be in the form of a panel or the like and is then further modified to form a different shape e.g. to introduce curved surfaces such as for use as a shower tray or sink.

The apparatus may be for use as a tray for a shower enclosure in a domestic and/or commercial setting. The apparatus may be for use as a screen for a shower enclosure. Aptly, the apparatus is a bath or a sink. In one embodiment, the apparatus is a bathroom vanity unit.

Aptly, the apparatus is for use in commercial and/or residential settings. The apparatus may be for use in an office environment, e.g. as a desktop or reception desktop surface. Aptly, the apparatus is for use as a countertop in a commercial setting e.g. in shops, hotels, leisure centres and the like.

The worktop may be for use in an industrial setting e.g. a laboratory or factory. The apparatus may be for use as a top for a table e.g. a dining table. Aptly, the apparatus is for use as a flooring panel. In one embodiment, the apparatus is for use as a wall panel. Aptly, the apparatus is for use as building cladding.

Aptly, the apparatus provides a terrazzo surface. Aptly, the apparatus provides a terrazzo surface which comprises recycled glass chips. Certain embodiments of the present invention therefore provide an environmentally friendly surfacing apparatus.

### FIGURES

Embodiments of the present invention will now be described hereinafter, by way of example only, with reference to the accompanying drawings in which:

FIG. 1 is a perspective side view of a panel formed by methods of certain embodiments of the present invention;

FIG. 2 is a perspective side view of an enclosure of certain embodiments of the present invention;

FIG. 3 illustrates different stages of the method of certain embodiments of the present invention. FIG. 3A illustrates a cross section view of the enclosure containing an intermediate mixture produced by the method of certain embodiments of the present invention. FIG. 3B illustrates a cross section view of the enclosure containing a mixture produced by certain embodiments of the present invention;

FIG. 4 illustrates a mold receiving station of the assembly of certain embodiments of the present invention. FIG. 4A is a top view of the mold receiving station. FIG. 4B is a side view of the mold receiving station. FIG. 4C is a front view of the mold receiving station. FIG. 4D is a side perspective view of the mold receiving station whilst FIG. 4E illustrates the mold receiving station with a mold positioned on the upper surface thereof;

FIG. 5 illustrates a plurality of deflecting blade elements according to certain embodiments of the present invention. FIG. 5A illustrates a deflecting member 201 comprising a plurality of deflecting blade members. FIG. 5B is a cross-sectional view of the deflecting member of FIG. 5A. FIG. 5C is a side view of a deflecting blade member;

FIG. 6 is a view of an aggregate distribution apparatus according to certain embodiments of the present invention;

FIG. 7 is an exploded view of certain elements of the aggregate distribution apparatus according to certain embodiments of the present invention;

FIG. 8 is a side view of an aggregate distribution apparatus according to certain embodiments of the present invention;

FIG. 9 is an end view of an aggregate distribution apparatus according to certain embodiments of the present invention;

FIG. 10 illustrates a storage region of an apparatus according to certain embodiments of the present invention;

FIG. 11 illustrates a lourve system of an apparatus according to certain embodiments of the present invention;

FIG. 12 illustrates a tensioning element of an apparatus according to certain embodiments of the present invention;

FIG. 13 is a cross sectional view of the tensioning element of FIG. 12;

FIG. 14 illustrates a mold levelling station of an assembly of certain embodiments of the present invention. FIG. 14A is a top view of the mold levelling station. FIG. 14B is a end view of the mold levelling station. FIG. 14C is a side view of the mold levelling station. FIG. 14D is a top perspective view of the mold levelling station. FIG. 14E is a side perspective view of the mold levelling station;

### DETAILED DESCRIPTION OF CERTAIN EMBODIMENTS OF THE INVENTION

Certain non-limiting examples of embodiments of the present invention will now be described in more detail below with reference to the accompanying drawings. In the drawings like reference numerals refer to like parts.

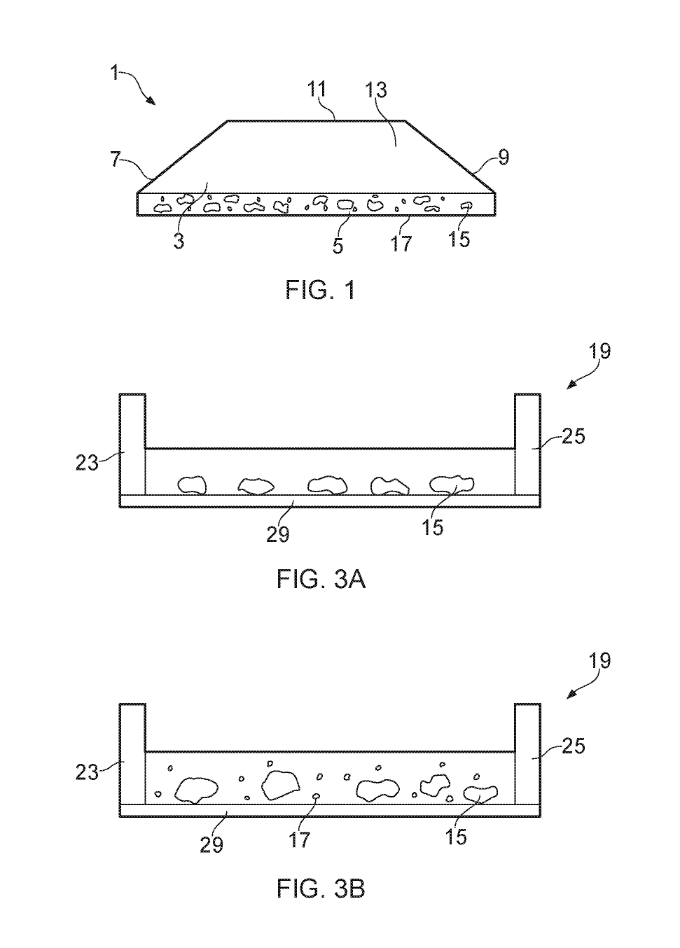

FIG. 1 illustrates an apparatus 1 in the form of a panel which is produced using the methods described herein. The panel 1 includes a body 3. The panel further includes a front edge 5, a first side edge 7, a further side edge 9 and a rear edge 11.

The panel provides an upper contact surface 13. The upper contact surface may be decorative and show various patterns and/or different colours, e.g. formed by the aggregate material used. In embodiments in which the apparatus is a panel, typical dimensions may be for example 1000 mm by 3000 mm. In one embodiment, the panel has dimensions of approximately 1220 mm by 3050 mm. In one embodiment, the mold is approximately 700×3050 mm or 1 m>3050 mm or 1 m×4 m. Aptly, the apparatus has a thickness of between about 4 mm to about 30 mm. In one embodiment, the panel is approximately 4 to 8 mm in thickness. The panel may be for attachment to an underlying panel composed of a material which differs from the surfacing apparatus. Thus, the apparatus 1 may form a layer in a multilayer apparatus. In one embodiment, one or more layers are formed from a material selected from wood, concrete, metal and chipboard.

It will be appreciated that the dimensions of the panel will alter depending on the intended use of the apparatus. Aptly, the panel includes at least two types of aggregate component, 15, 17.

FIG. 2 illustrates an enclosure 19 for use in the method of the present invention. Aptly, the enclosure 19 is a mold and its dimensions correspond to the desired dimensions of the initial apparatus to be formed. It will be appreciated that the mold can have a wide range of different shapes, sizes etc. FIG. 2 illustrates a mold suitable for producing a panel e.g. for use as a counter top or table surface. The panel may be subject to further modification such as heating to further shape it e.g. to introduce curved surfaces.

The enclosure 19 includes a front wall 21, a side wall 23, a further side wall 25 and a back wall 27. The enclosure further includes a base panel 29 which is lower than the top surface of the surrounding walls. The walls may be for example 6 mm to 30 mm in thickness.

In one embodiment, the enclosure sits on top of a vibrating table 31 which includes a vibrating mechanism 33 and a motor (not shown).

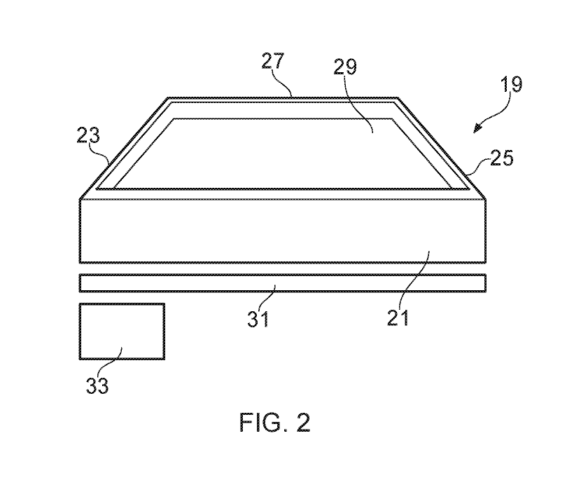

FIG. 3 is a cross section through the enclosure of FIG. 2. FIG. 3A shows a cross section of the enclosure filled with a liquid resin component, a liquid curing agent and a first (largest and/or heaviest) aggregate material 15. The first aggregate material sinks to the bottom of the liquid mixture when first poured into the enclosure. FIG. 3B shows a cross section of the enclosure following further addition of a second (smaller and/or less heavy) aggregate material 17 and vibration of the mixture as described below in the Examples.

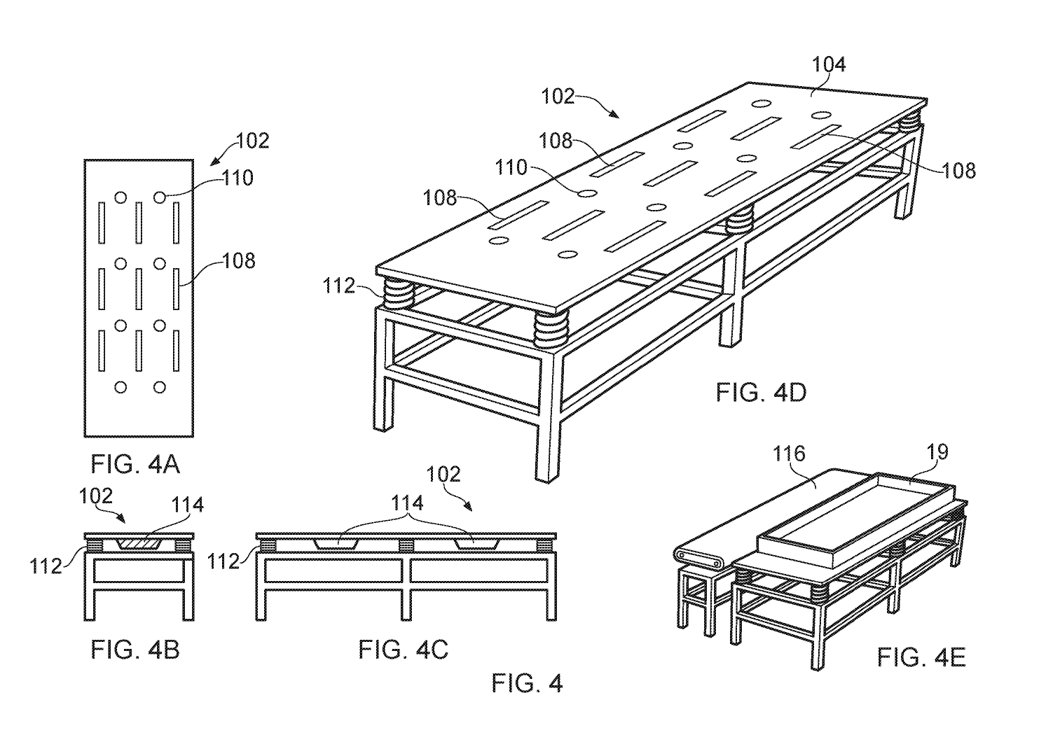

FIG. 4 illustrates a mold receiving station 102 which may form part of an assembly as disclosed herein. The mold receiving station may be in the form of a table. The table is for supporting the enclosure e.g. the mold 19. The assembly also includes a transfer platform 116. FIG. 4e depicts the mold positioned on the upper surface of the mold receiving station 102.

FIGS. 4a to 4e illustrate the mold receiving station 102 in more detail. The mold receiving station includes a table which has an upper surface 104 which is sized to support the mold 19. Therefore, the dimensions of the table are not necessarily important provided the mold is fully supported and so substantially level. Exemplary dimensions of the mold are provided herein. The surface 104 is substantially flat. The upper surface 104 includes at least one transfer element for aiding transfer of the mold to the mold receiving station and subsequently to an aggregate addition station 106 which is described below.

In the illustrated embodiment, the transfer elements are a series of rollers 108 which are positioned along and set into the upper surface 104 of the mold receiving station 102. In the illustrated embodiment, the rollers 108 move in a direction perpendicular to the length of the mold receiving station 102. The rollers are air activated to rise and fall to ensure a contact with the mold.

In other embodiments which are not illustrated, the transfer elements may comprise for example jets of air projected upwardly from the upper surface of the table. Alternatively, the transfer elements may be a trolley or other mechanism known to those skilled in the art.

The upper surface 104 of the table of the mold receiving station 102 also comprises at least one receiving element which positions and releasably secures the mold 19 to the upper surface 104. FIG. 4 shows the receiving elements as a plurality of vacuum clamps 110. The vacuum clamps are each attached to a compressed air line (not shown) via an air actuator that causes a vacuum that is used to clamp the mold.

The vacuum clamps each include a vessel with two opposing openings, each with a sealed rubber perimeter which pushes against the parallel surfaces to be secured.

Once the mold 19 is transferred to the upper surface 104, it is positioned at the desired location. Downward pressure is then applied to the enclosure e.g. the mold 19 to create a vacuum between a lower surface of the mold and one or more vacuum clamps in order to secure the mold to the upper surface. The vacuum clamps thus keep the mold secured during vibration of the table.

Once the enclosure is secured in place, a resin and curing agent mixture, which is pre-mixed, is added to the mold. The mold receiving station comprises a plurality of spring isolators 112 positioned at each corner on an underside of the first table. The mold receiving station includes at least one motor 114 which vibrates both the upper surface, and therefore the mold secured thereon so evenly distributing the resin mixture in the mold.

The enclosure e.g. the mold 19 is vibrated for e.g. 10 minutes at a resonance described herein which is sufficient to cause the resin mixture to be spread evenly in the mold. Vibration of the resin mixture in the mold also allows air inclusions to escape from the upper surface of the resin.

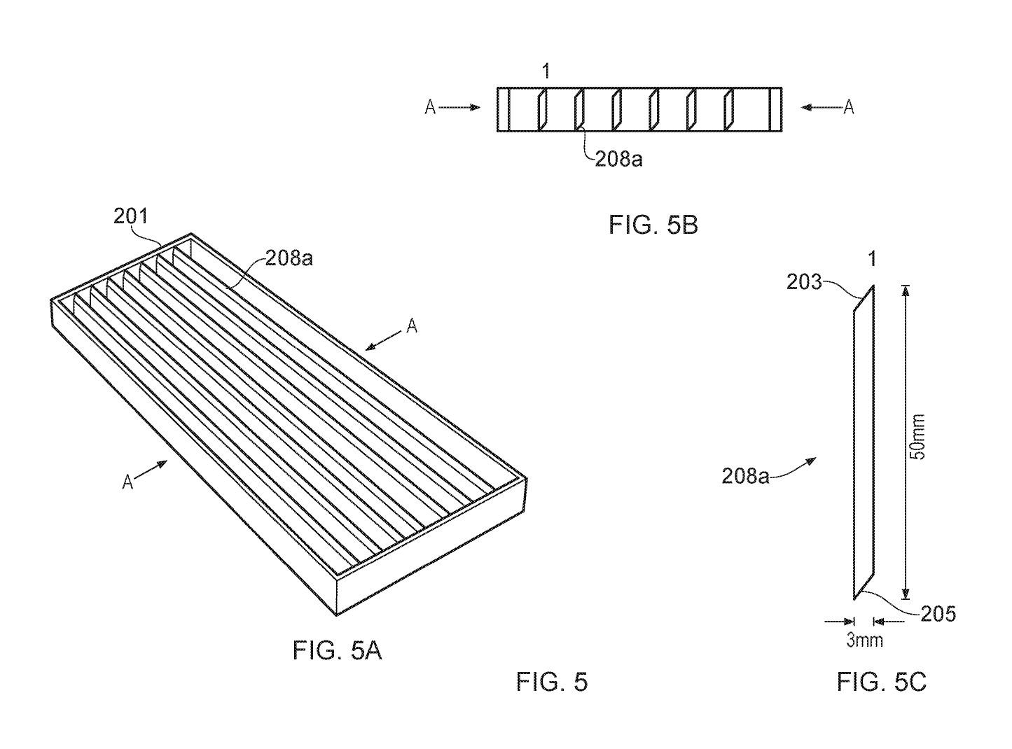

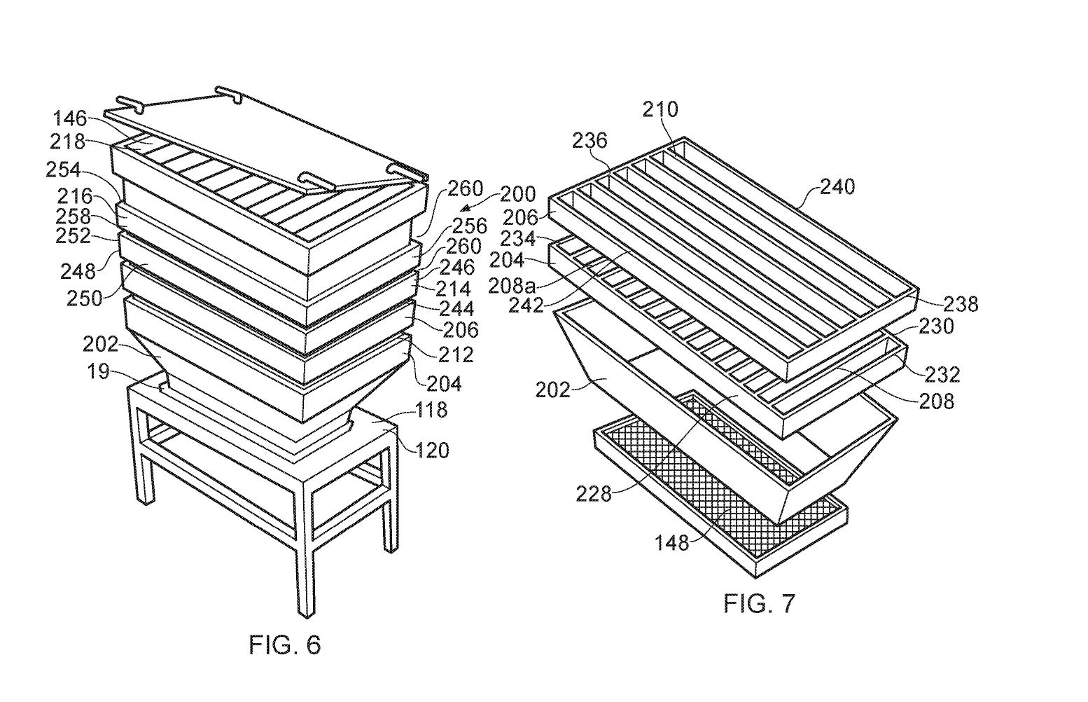

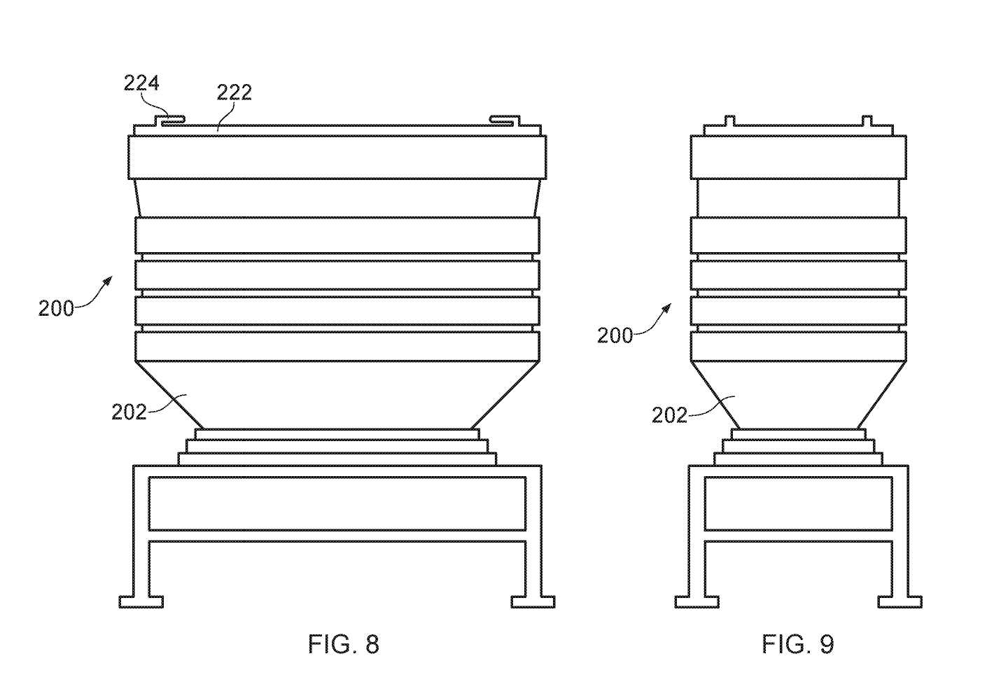

Aptly, the mold is then transferred to a further support and is located beneath an apparatus 200 according to certain embodiments of the present invention. Elements of the apparatus 200 are illustrated in FIGS. 5 to 13. The mold may be transferred to a location beneath the apparatus 200 using a transfer platform which is positioned between the mold receiving station and a station comprising the apparatus 200.

The apparatus 200 may be located above a table 120 which includes an upper surface 118. The table 120 may have similar dimensions to the table of the mold receiving station and is sized to accommodate the mold. The table 120 may also comprise a plurality of spring isolators (not shown) each connecting the upper surface 118 to a table frame (not shown).

FIG. 5 illustrates an apparatus 200 for distributing aggregate material. In one embodiment, the aggregate material is for use in a surface apparatus, e.g. a panel. Details of the surface apparatus are provided herein. The aggregate material may be for example glass chips. Details of aggregate material are provided herein.

The apparatus 200 may be used to distribute aggregate material in to a wide variety of elements including for example a mold 19, as shown in FIG. 2 and FIG. 3. Elements of the apparatus as described below.

The apparatus 200 is made of any suitable material for example steel, or other metal materials. In one embodiment, the apparatus is used to apply a vacuum to an enclosure into which the aggregate is distributed. In such embodiments, the apparatus is made of a material which is strong enough to withstand the application of negative pressure.

The apparatus 200 comprises a tapered portion 202 at a lower section of the apparatus. The tapered portion acts as a chute and is sized to correspond in shape at its lower end 226 to an enclosure e.g. a mold 19 into which the aggregate material is distributed.

The apparatus 200 further comprises one more deflecting members e.g. frame members generally referred to as 201. The deflecting blade members are shown in detail in FIG. 5.

A first deflecting member 204 of the apparatus 200 is illustrated in FIG. 7. The first deflecting member of the illustrated embodiment is a frame member which may be removed from the apparatus. In alternative embodiment, the deflecting member is an integrally formed element of the apparatus. A first frame member 204 sits on top of the tapered portion. Aptly, the deflecting member e.g. the frame member 204, comprises a plurality of deflecting blade members. The frame members may have a depth of approximately 50 mm.

In the illustrated embodiment, the first frame member 204 is generally rectangular in shape. It will be understood that in alternative embodiments, the first and further deflecting members may be other shapes e.g. circular, square and the like.

The first frame member 204 comprises a first side wall 228 and a second side wall 230. The first frame member 204 also includes a first end wall 232 and a second end wall 234.

Extending between the first side wall 228 and the second side wall 230 is a first plurality of tapered slats or blade members 208. The first frame member may comprise more than ten blades e.g. 15 or 20 blades.

Each blade 208a may have an angled upper surface 203 as shown in FIG. 5C. The angled nature of the upper surface results in aggregate components which fall onto the angled surface are deflected away from its generally vertically downward path into an at least partially transverse pathway. In addition, each blade 208a may have an angled lower surface 205.

Aptly, each blade is approximately 50 mm in depth and has a thickness of approximately 3 mm. It will be understood that in alternative embodiments the apparatus may comprise blade members of differing dimensions.

The apparatus 200 further comprises a second frame member 206 which in the illustrated embodiment is positioned above the first frame member. The first frame member and the second frame member may be separated by a spacing member 212. In alternative embodiments, the apparatus does not comprise the spacing member 212. The spacing member may be approximately 50 mm in depth.

The second frame member comprises a first end wall 236 and a second end wall 238. In addition, the second frame member comprises a first side wall 240 and a second side wall 242. A second set of blade members 210 extend between the first end wall 236 and the second end wall 238.

In the illustrated embodiment, each blade of the second plurality of blades is perpendicular to each blade of the first set of blades. That is to say, if viewed from above, the first set of blades and the second set of blades form a grid comprising a plurality of square sections.

It will be understood that in alternative embodiments, the first set of blades need not be perpendicular to the second set of blades and may instead be at an angle other than 90° relative to the second set of blades.

The apparatus 200 may further comprise further frame members e.g. a third frame member 214 which is positioned on top of the second frame member. A spacing element 244 may be provided between the second frame member and the third frame member. The third frame member 214 comprises a first end wall 246, a second end wall 248, a first side wall 250 and a second side wall 252. A third set of blade members extends between the first side wall and the second side wall. Thus, in the illustrated embodiment, each blade of the third set of blades is parallel to a blade of the first set of blades. Each blade of the third set of blades is offset from a corresponding blade of the first set of blades such that no blade of the third set of blades is positioned directly above a blade of the first set of blades.

The apparatus 200 may additionally comprise a fourth frame member 216. The fourth frame member is positioned above the third frame member. A spacing element may be provided between the third and fourth frame member. The fourth frame member 216 includes a first end wall 254, a second end wall 256, a first side wall 258 and a second side wall 260.

A fourth set of blades extends between the first end wall and the second end wall of the fourth frame member. The fourth set of blades comprises a plurality of blades which are parallel to corresponding blades of the second frame member. Each blade of the fourth set of blades is offset from a corresponding blade of the second set of blades such that no blade of the fourth set of blades is positioned directly above a blade of the second set of blades.

The apparatus 200 may comprise two or more frame members comprising a set of blades e.g. two, three, four, five or further frame members. Aptly, each set of blades comprises a plurality of tapered blades as described above.

Each of the first, second, third, fourth and further frame members may comprise the same number of blades or a different number of blades. The blades of the first, second, third, fourth and/or may be fixedly attached to their respective frame member. Each frame member and corresponding set of blades may be integrally formed.

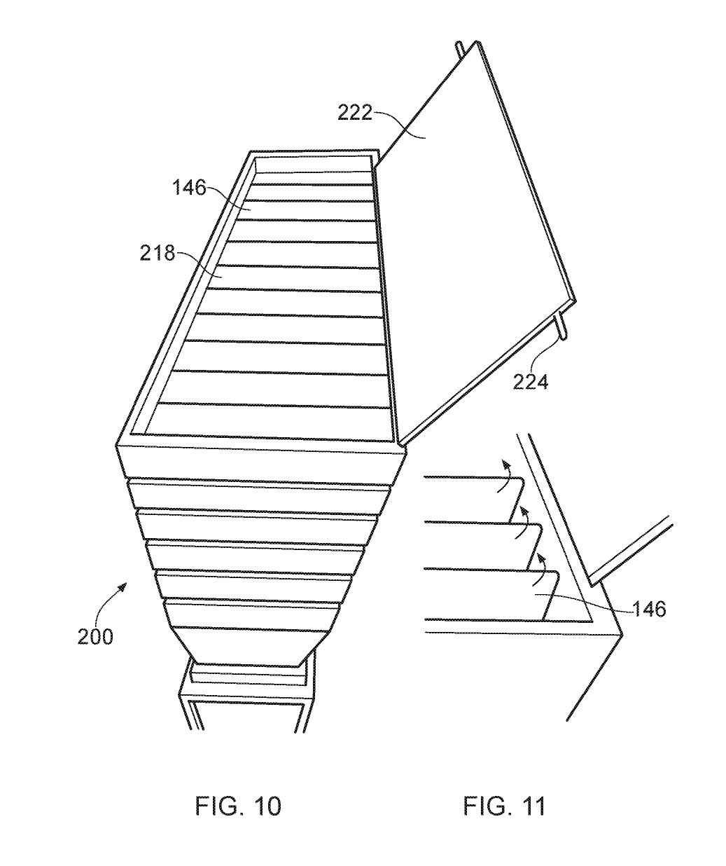

As shown in FIG. 10 and FIG. 11, the apparatus 200 comprises an aggregate storage region 218. The aggregate storage region 218 comprises a plurality of elongate slats or louvre panels 146 positioned in a base region of its interior and between the storage region and the deflecting member(s). The slats 146 are illustrated in FIG. 10 and FIG. 11 and are rotatable about a pivot to move between an open position and a closed position, as illustrated in FIG. 10 and FIG. 11. The slats may be composed of wood, metal or any other suitable material. Aptly, each slat is approximately 50 mm to 100 mm in width. Aptly, the slats are each approximately 75 mm in width.

When the slat edges are in the closed position, the slats overlap to form a continuous surface across the interior area of the container. When the slats are in the closed position, aggregate can be poured into the storage region 218, so falling onto the surface of the closed slats and retained within the container. When required, the slats are pivoted to an open position, as shown in FIG. 11, causing aggregate to fall between the slats.

The apparatus 200 may additionally comprise a lid element 222. In certain embodiments, the lid element may comprise a sealing mechanism (not shown) to enable a vacuum to be applied to the apparatus which in turn applies a negative pressure to enclosure in which the aggregate material is being distributed. In these embodiments, the apparatus comprises an inlet port for negative pressure (not shown). The lid element 222 may further comprise one or more handles 224 which can be used to remove the lid from the apparatus to allow aggregate to be loaded on top of the lourve panels when in a closed position.

The apparatus may also comprise a motor or other element (not shown) for vibrating the meshes and/or one or more frame members. The motor may be mounted on the apparatus.

Each element of the apparatus may be separable from other elements. Alternatively, the apparatus may be a single unitary structure.

Once released from the lourve panels, the aggregate material falls in a downward pathway. At least a portion of the aggregate material will fall onto the tapered upper surface of the blades of the uppermost frame member. In the illustrated embodiment, the uppermost frame member is the fourth frame member. Any aggregate material component that falls onto one of the blades will be deflected from its downward pathway to at least partially transverse second pathway.

In addition, interruption of the aggregate component's downward pathway will reduce the speed of fall of the aggregate component.

The aggregate material continues to fall and a portion of the aggregate material will fall onto the blades of a lower positioned frame member. In the illustrated embodiment, the aggregate material falls onto the frame member positioned underneath the uppermost frame member.

The aggregate material which falls onto the blade member is deflected from its original pathway.

This is repeated for each frame member provided in the apparatus. As a result, aggregate material is deflected such that individual aggregate components fall in a plurality of pathways. Falling aggregate components may additionally contact other falling aggregate components which may alter the pathway direction of the individual aggregate components. The aggregate material subsequently falls through the chute to a mesh provided at a lower portion of the apparatus. The mesh is vibrated and the aggregate material falls through the mesh into the enclosure below.

The apparatus may comprise more than one mesh. The meshes may be spaced apart by one or more spacing elements. The apparatus may additionally comprise one or more meshes 148 which are situated beneath the chute 202.

If more than one mesh is provided, the apertures of an upper mesh 148 may be in a non-aligned vertical relationship to the apertures of a lower mesh so that when a piece of aggregate passes through an aperture of the upper mesh, it is forced to fall in a labyrinthine path. That is to say, the aggregate piece may not immediately pass through an aperture of the lower mesh and fall vertically downwards.

The mesh apertures are sized to allow the aggregate pieces to pass through. The provision of one or more meshes reduces the speed of fall of the aggregate which may allow fewer air inclusions to be incorporated into the resin mixture when the aggregate hits the surface of the resin mixture in the mold.

Aptly, the container may include one, two, three or more meshes. Aptly, the meshes are provided across the whole interior of the container and are provided one above the other. Aptly, the one or more meshes are provided beneath the deflecting members. Each mesh may have apertures that differ in size to the aperture of the further meshes, provided that the apertures permit the aggregate to pass through.

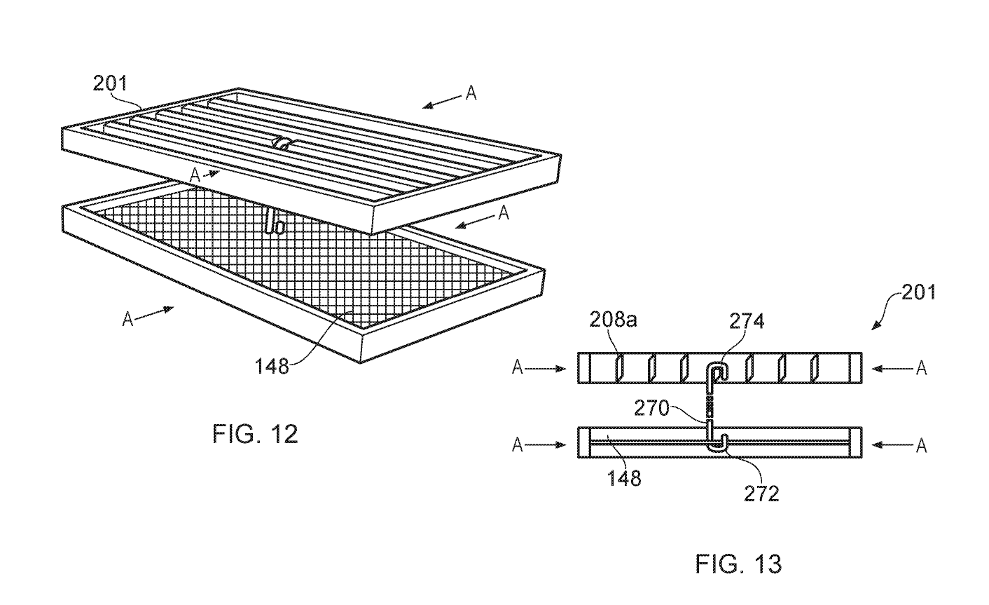

The mesh layer may be tensioned by way of a tensioning member 270, as shown in FIG. 12 and FIG. 13. The illustrated tensioning member is a rigid rod comprising a hooked region at an upper end 274 and a lower end 272. The upper hook fits over a blade whilst the lower hook engages with struts of the mesh layer so as to apply tension to the mesh.

Tensioning of the mesh may help to ensure an even distribution of aggregate from the mesh. In embodiments in which the tensioning member is provided at least one blade of a lower frame member may comprise a slot in which the upper hook 274 may be located.

Aggregate material which falls on to a mesh without having first fallen through and abutted the blade system described herein has a tendency to congregate at a central region of the mesh. This has the disadvantage of uneven distribution of aggregate material in the enclosure positioned beneath the mesh. The provision of one or more aggregate material deflection elements e.g. the one or more frame members with a set of blades as illustrated herein act to distribute the aggregate material more evenly and reduces or avoids the overfilling towards the centre of the enclosure.

The result is that aggregate material is distributed across a greater surface area and is therefore more evenly spread at a target location e.g. within a mold. Thus, if the mold is filled with a resin component, the aggregate material will be more evenly distributed within the resin material as compared to panels formed by other aggregate distribution methods which do not use the deflecting blade members as described herein. Using the apparatus and methods comprising the use of the blade system may result in a surface apparatus, e.g. a panel for use as a worktop, having aggregate e.g. glass chips more evenly distributed across the entire surface area of the panel. Prior art methods often result in a greater concentration of aggregate in central areas of a panel as compared to the outer perimeter. This is clearly aesthetically undesirable.

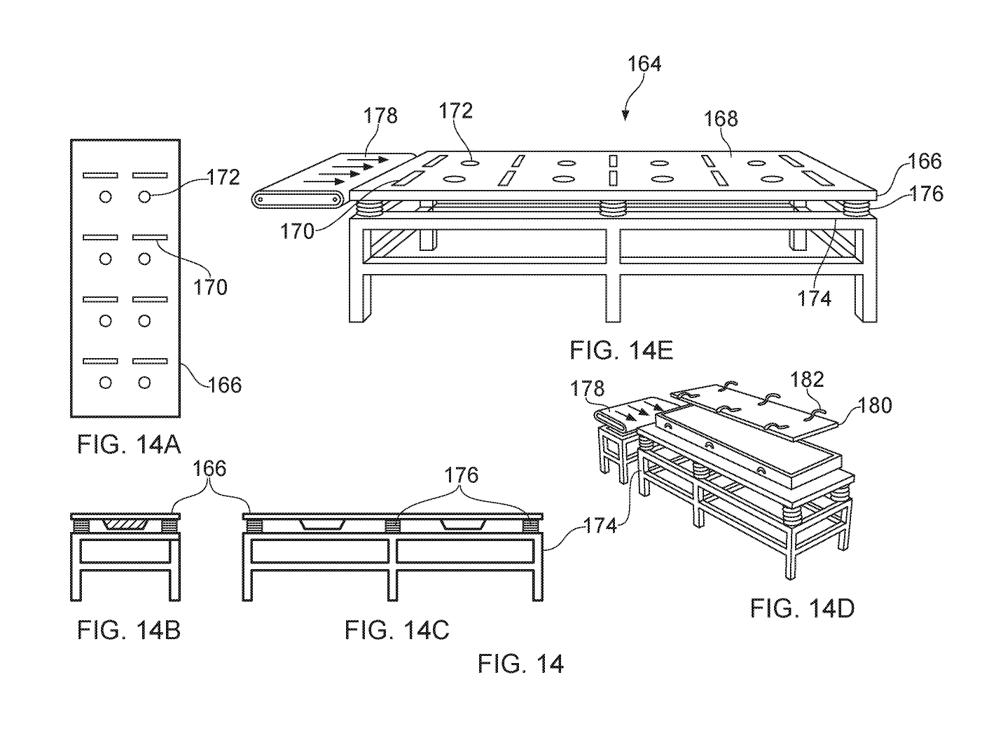

Once the aggregate material has been distributed at the target location e.g. in the mold, the mold may be moved to a location where it can be levelled. The illustrated assembly comprises a levelling station 164 as shown in FIG. 14. The levelling station 164 includes a third table 166 having an upper surface 168. The upper surface include transfer elements e.g. rollers 170 which are as described above in relation to the mold receiving station. The upper surface of the table may comprise two or more rollers, e.g. 3, 4 5, 6, 7, 8, 9 and/or 10 rollers. The upper surface of the table also includes vacuum clamps 172 which are similar to those provided in the mold receiving station. The upper surface 168 is connected to a frame 174 of the table 166 via a plurality of springs 176.

The mold can be transferred from the aggregate addition station to the levelling station via a second transfer platform 178. The transform platform may comprise a roller conveyor which moves the mold to the levelling station from the table of the aggregate addition station. The third table may also include one or more vibrating motors (not shown).

### EXAMPLES

An embodiment of the method of the present invention is described in a non-limiting manner below:

Initially, an enclosure e.g. a mold is prepared. The mold has fixed edges, the height of which is dependent on the required thickness of the apparatus to be produced. The size and dimension of the mold determines the size and dimension of the apparatus e.g. a panel. In the illustrative embodiment, the mold has a rectangular base of approximately 1220 mm by 3050 mm and have sides of approximately 20 mm in height.

Other suitable mold dimensions include for example 1220 mm×4050 mm and 1000 mm×3000 mm or the like.

The mold is manufactured from melamine faced MDF which provides a polished, non-stick surface which allows easy removal of the apparatus once cured. Of course, the mold may be manufactured from any other suitable material than can contain the components and tolerate the curing and vibrating conditions. The mold is positioned at a pouring station and on a table which is capable of vibrating at differing frequencies. The vibrating table is fitted with springs which isolate the table top from the supporting legs to diminish the energy loss and damage.

The table also includes an inverter for varying the frequency and force of vibration. Vibration tables which may be used in the present invention include those manufactured by VIBTEC.

The method is carried out at ambient temperature and in a dry environment with air extraction.

The resin, e.g. an epoxy resin, UKR137, and a curing agent, e.g. UKH136 are mixed together prior to being poured into the mold to a defined level which is determined by the thickness, type, and size of aggregate. Further components such as pigments and defoamers may also be added at this stage if desired or added prior to activation of the resin component. UKR137 contains a defoamer and therefore a separate defoamer is not required in this embodiment. A small amount (e.g. 0.10% of the final composition of the apparatus) of a silane (silane 187) is also added at this stage. The components are mixed together using a mechanical plaster mixer.

Aptly, the mixture comprises resin: curing agent at a ratio of 2:1 (by volume).

The mold is vibrated at a low frequency (approx. 25 Hz) whilst the resin/curing agent mixture is added to the mold. The vibration caused encourages any air inclusions which are present to escape from the mixture. The mold is vibrated for approximately five minutes in this step.

Aggregate material is then added to the mold. Aptly, aggregate material is added to the storage region of the apparatus with the lourve panels in the closed position. The lourve panels are then rotated into an open position to release the aggregate material in a downward pathway. The lourve panels may deflect some of the aggregate material in an at least partially transverse pathway. The aggregate material subsequently falls towards the uppermost plurality of deflecting blade members. A portion of the aggregate material will fall onto the angled upper surface of a blade member, causing it to alter the direction of its downward trajectory. A portion of the aggregate material will fall between adjacent blade members and its trajectory will be unaffected by the first plurality of deflecting blade members.

The aggregate material continues its downward motion and at least a portion will fall onto the angled upper surface of a further plurality of deflecting blade members. The further plurality is provided in a perpendicular relationship with the first set of deflecting blade members.

The apparatus may further comprise additional sets of deflecting blade members. Each further set is provided parallel to every-other-one set or plurality of deflecting blade members. Furthermore, each further set of deflecting blade members are disposed in an at least partially off-set location relative to every-other-one set or plurality of deflecting blade members. That is to say that each deflecting blade member of each further plurality of blade members is disposed such that it is not directly underneath or above a corresponding blade of the every-other other one plurality of blade members. Aptly, by providing further pluralities of blades in a non-aligned pattern, a greater proportion of the aggregate material will contact at least one blade and its trajectory altered in a transverse direction. The aggregate material falls onto the mesh, which is aptly vibrated. The aggregate material subsequently falls through the mesh layer into the mold below.

Approximately 75 litres or 150 kg of the first aggregate material is used in a mold having the dimensions of 1220 mm×3050 mm×20 mm.

The vibration of the mold may then be increased in frequency and/or force during the addition of the first aggregate material and maintained following the addition of the first aggregate material. The high frequency vibration has a frequency of approximately 32 Hz. The increase in vibration frequency allows air which is present in the mixture is to be released from the surface of the mixture in the mold. The aggregate, resin, curing agent mixture is subject to the high frequency vibration for approximately five to ten minutes. The aggregate material typically sink to the bottom of the mold during this step.

Aptly, an amount of a different type of aggregate material is then added. The second aggregate, e.g. scattered mirror, has a lower density per surface area than the first aggregate material. The second aggregate is added at the same rate as the first aggregate or at a slower rate to keep air inclusion to a minimum. The mold is vibrated at the same or substantially the same frequency as the vibration used during the addition of the first aggregate material. In some cases, the frequency of the vibration may be reduced for a short period of time to allow the aggregate material to settle.

The mold is vibrated until the second aggregate has been added to the mixture. The second aggregate material sinks within the liquid mixture to between individual elements of the first aggregate component. Following the addition of the second aggregate material, further aggregate materials may be added if required.

In certain embodiments, the aggregate material is distributed substantially at the same time as a negative pressure is supplied to the apparatus and is applied at the enclosure.

Once all of the aggregate materials have been added to the activated resin component, an optional further step is the addition of a thin layer of activated resin component to the upper surface of the mixture. The provision of an upper layer of activated resin component may help to prevent the upper surface becoming brittle post curing. The mold is vibrated whilst the activated resin component is poured onto the top surface of the mixture. The resin components used to form an upper layer is the same as that used throughout the process.

Aptly, the mixture is then levelled by pulling a flat bar pulled across the upper surface of the mold whilst vibration is applied. The vibration applied during levelling may have a frequency of between about 25 Hz and 42 Hz.

The mold is then removed from the pouring station to be cured. The composite mixture is cured at ambient temperature for between 12 to 24 hours, depending on the surrounding temperature. Once cured, the resulting panel is removed from the mold, the lower surface is calibrated and the upper surface polished to ensure a smooth profile.

If required, the storage region above the lourve panels may be filled with a further aggregate component, e.g. one which comprises smaller aggregate pieces or pieces of a different aggregate material. Prior to re-filling the container, the slats are rotated to a closed position. The above process may then be repeated.

The process may be repeated to provide further aggregate materials if required.

Once the aggregate material have been added, the mold, which is now filled with an aggregate-resin mixture, can be transferred to the levelling station via a second transfer element 178. The upper surface of the aggregate-resin mixture can be levelled. If required the upper surface of the mixture can also pressed using a panel 180 comprising handles 182.

Once the required aggregate has been added, the mold may be vibrated for a predetermined length of time before being transferred to the levelling station as described above. The resin aggregate mixture can be levelled to a predetermined thickness using for example a trowel, a levelling edge, a press or vibratory compaction. In one embodiment, the thickness is between about 6 mm and about 20 mm.

Once the aggregate-resin mixture has been levelled and optionally pressed, the mold may be transferred to a curing station (not shown) where the mixture is cured. The mixture may be cured at a surrounding temperature of between about 10° C. and about 35° C.

Optionally, following curing heat can be used to bend the panel into a desired shape e.g. a sink or the like.

Throughout the description and claims of this specification, the words “comprise” and “contain” and variations of them mean “including but not limited to” and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

In certain embodiments, there is provided a method of manufacturing an apparatus that provides a surface and which comprises a resin component and an aggregate component, the method comprising:
a. pouring a resin component and a curing agent into an enclosure;
b. vibrating the enclosure in a first vibration mode so as to agitate the resin and curing agent;
c. adding a first aggregate component to the enclosure;
d. vibrating the enclosure in a further vibration mode so as to agitate the resin component, curing agent and aggregate component and form a resin/curing agent/first aggregate component mixture.

In certain embodiments the further vibration mode has a greater amplification and/or frequency than the first vibration mode. In certain embodiments, the method comprises mixing the resin component and the curing agent together to form an activated resin component prior to being poured into the enclosure in (a). In certain embodiments the resin/curing agent mixture is a liquid. In certain embodiments the step of applying the further vibration mode comprises encouraging air to be released from an upper surface of the resin/curing agent/first aggregate component mixture.

In certain embodiments, the method comprises: (e) adding a second aggregate component to the enclosure to form a mixture comprising a first aggregate component, a second aggregate component, a resin component and a curing agent, wherein the second aggregate component has a lower average weight than the first aggregate component. Aptly, step (d) is carried out prior to step (c). In certain embodiments, the first vibration mode has a frequency of vibration of between about 20 and 45 Hz, e.g. about 20, 25, 30, 35, 40 or 45 Hz.

In certain embodiments the method comprises applying the first vibration mode for between about 1 minute and 10 minutes e.g. about 1, 2, 3, 4, 5, 6, 7, 8, 9, or 10 minutes. Aptly, the further vibration mode has a frequency of vibration greater than about 25 Hz e.g. 30, 35, 40, 42, or 45 Hz. In certain embodiments, the method comprises applying the further vibration mode for between about 1 minute and 10 minutes e.g. about 1, 2, 3, 4, 5, 6, 7, 8, 9, or 10 minutes.

In certain embodiments the method comprises adding further aggregate components to the enclosure, wherein optionally each further aggregate component has a lower average weight than each aggregate component previously added. In certain embodiments the method further comprises the step of positioning the enclosure containing the resin component and the curing agent below an aggregate container prior to step (c).

In certain embodiments the method further comprises loading the aggregate container with the first aggregate component and optionally at least one further aggregate component. In certain embodiments, the method further comprises the step of re-directing a vertical falling motion of the aggregate component(s) released from the container via at least one mesh layer located between the aggregate component(s) loaded in the aggregate container and the enclosure.

In certain embodiments the method further comprises the steps of: deflecting falling aggregate component(s) in a transverse direction with respect to a vertical downward direction, via struts of a lower mesh layer having openings offset with respect to openings of an adjacent mesh layer.

In certain embodiments the aggregate container comprises at least one mesh layer. In certain embodiments, the aggregate container comprises a plurality of mesh layers. In certain embodiments, the aggregate container comprises a base region and a plurality of elongate parallel panels in the base region, wherein the elongate parallel panels are rotatable from an open position in which edges of the panels are spaced apart and a closed position in which edges of adjacent panel members at least partially overlap.

In certain embodiments, the aggregate container is loaded with the first aggregate component, and optionally the further component(s), when the panels are in a closed position.

In certain embodiments the panels are rotated from the closed position to the open position to release the aggregate component(s) from the container.

In certain embodiments, the method further comprises the steps of:
re-directing a vertical downwards falling motion of aggregate component(s) released from the container by locating a region of an upper surface of each panel between the container and the enclosure in the open position.

In certain embodiments the method further comprising the steps of:
releasing the aggregate component substantially simultaneously across an entire area of a bottom region of the container by rotating the panels in common by the same angle of rotation.

In certain embodiments, the method comprises imparting a transverse component into the falling motion of aggregate component by deflecting the aggregate component with said upper surface of the panel members.

In certain embodiments, the method further comprises the steps of:
re-directing a vertical falling motion of the aggregate component released from the container via at least one mesh layer located between the panels and the enclosure.

In certain embodiments, the method further comprises the steps of:
deflecting falling aggregate component in a transverse direction with respect to a vertical downward direction, via struts of a lower mesh layer having openings offset with respect to openings of an adjacent mesh layer.

In certain embodiments, the method further comprises providing a layer of activated resin component on an upper surface of the mixture in the enclosure, wherein the mixture comprises the first aggregate component, the second aggregate component, the resin component and the curing agent. Aptly, the method comprises levelling a top surface of the aggregate, resin component and curing agent mixture. In certain embodiments the method comprises vibrating the enclosure in a third vibration mode during the step of levelling.

Aptly, the third vibration mode has a frequency of vibration greater than about 25 Hz e.g. 30, 35, 40, 42, or 45 Hz. Aptly, the method further comprises the step of: curing the aggregate component, resin, curing agent mixture in the enclosure mixture.

In certain embodiments the method comprises curing the mixture of step (e) at an ambient temperature e.g. at a temperature of between about 17 to 25° C. In certain embodiments the method comprises removing the cured mixture from the enclosure.

In certain embodiments the method comprises heating and shaping the cured mixture to form the apparatus.

In certain embodiments the apparatus is selected from a countertop, a worktop, a table top, a desk top, a panel, wall panel, a shower tray, a shower screen or a floor panel. In certain embodiments the resin component comprises an epoxy resin or a polyester resin. In certain embodiments the curing agent comprises a cycloaliphatic polyamine. In certain embodiments the first aggregate component is selected from glass chips, stone chips, engineered stone chips, shells, plastic chips, mirror chips and metal chips. In certain embodiments the first aggregate component is a recycled material.

In certain embodiments the second aggregate component is selected from glass chips, stone chips, engineered stone chips, shells, plastic chips, mirror chips, metal chips, gold leaf and rare material chips e.g. rare glass chips.

In certain embodiments the second aggregate component is a recycled material.

In certain embodiments there is provided an apparatus for providing a surface obtainable from the method of any preceding paragraph, wherein the apparatus comprises a lower level of air inclusions as compared to an apparatus obtainable from methods which comprise mixing a resin, a curing agent and an aggregate at substantially the same time.

In certain embodiments there is provided an apparatus for providing a surface comprising an aggregate component and a cured resin, wherein the apparatus has a thickness of less than about 10 mm. In certain embodiments the apparatus has a thickness of approximately 6mm.

In certain embodiments the apparatus comprises approximately 50% to 90% less surface air inclusions than a panel obtainable by prior art methods. In certain embodiments the apparatus is a panel, a floor panel, a sink, a shower screen, a shower tray, a desk top, a counter top or a worktop.

In certain embodiments the aggregate component comprises glass chips, wherein optionally the glass chips are formed from recycled glass.

In certain embodiments the apparatus is comprised in a multi-layered apparatus and forms a first layer thereof. In certain embodiments the multi-layered apparatus comprises a second layer, wherein the second layer is formed from a material which differs from the first layer.

In certain embodiments, the second layer is formed from a material selected from wood, concrete and chipboard.

In certain embodiments, there is provided an assembly for manufacturing an apparatus that provides a surface and which comprises a resin component and an aggregate component, the assembly comprising:
an aggregate container for storing an aggregate component;
a support for supporting an enclosure containing an activated resin component below the aggregate container; and
a plurality of elongate parallel panels at a bottom region of the aggregate container; wherein
each panel is selectively rotatable about a respective longitudinal axis from a closed position in which edges of adjacent panels at least partially overlap, to an open position in which edges of the panels are spaced apart to allow an aggregate component to fall from the aggregate container.

In certain embodiments the assembly further comprises, in the open position, the panels are rotated to locate a region of an upper surface of each panel at least partially in a pathway of aggregate component falling from the container. In certain embodiments, the assembly further comprising at least one mesh layer located between the panels and the support.

In certain embodiments at least one mesh layer comprises a plurality of spaced apart, substantially parallel, mesh layers each comprising a plurality of openings wherein openings in a mesh layer are offset with respect to openings in an adjacent mesh layer.

In certain embodiments there is provided assembly for manufacturing an apparatus that provides a surface and which comprises a resin component and an aggregate component, the assembly comprising:
an aggregate container for storing aggregate component;
a support for supporting an enclosure containing a activated resin component below the aggregate container; and
at least one mesh layer at a bottom region of the aggregate container.

In certain embodiments, the at least one mesh layer comprises a plurality of spaced apart, substantially parallel, mesh layers each comprising a plurality of openings wherein openings in a mesh layer are offset with respect to openings in an adjacent mesh layer.

Aptly, the assembly comprises at least one motor for vibrating the aggregate container and/or the support. Aptly the assembly further comprises at least one further support for supporting the enclosure. In certain embodiments, the at least one further support comprises at least one transfer element for transferring the enclosure to the further support. In certain embodiments the at least one transfer element comprises a roller. In certain embodiments the at least one further support comprises at least one securing element for releasably securing the mold to an upper surface of the support. In certain embodiments the at least one securing element comprises a vacuum clamp.

In certain embodiments there is provided a method of manufacturing an apparatus that provides a surface and which comprises a resin component and an aggregate component, comprising the steps of:
providing an enclosure containing a resin component below an aggregate container; and
releasing an aggregate component at a bottom region of the container by rotating a plurality of elongate parallel panels from a closed position in which edges of adjacent panel members at least partially overlap to an open position in which edges of the panels are spaced apart.

In certain embodiments the method further comprises the steps of:
re-directing a vertical downwards falling motion of aggregate component released from the container by locating a region of an upper surface of each panel between the container and the enclosure in the open position.

In certain embodiments the method further comprises the steps of:
re-directing a vertical falling motion of aggregate component released from the container via at least one mesh layer located between the panels and the enclosure.

In certain embodiments the method further comprises the step of:
deflecting falling aggregate component in a transverse direction with respect to a vertical downward direction, via struts of a lower mesh layer having openings offset with respect to openings of an adjacent mesh layer.

In certain embodiments the method comprises the step of:
releasing the aggregate component substantially simultaneously across an entire area of a bottom region of the container by rotating the panels in common by the same angle of rotation.

In certain embodiments, the method further comprises the step of:
imparting a transverse component into the falling motion of aggregate component by deflecting the aggregate component with said upper surface of the panel members.

1-43. (canceled)

44. An apparatus for distributing aggregate material at a target location, the apparatus comprising:
a) an aggregate release device for selectively releasing aggregate material from a storage region;
b) a first plurality of deflecting blade members orientated in a first orientation; and
c) a further plurality of deflecting blade members orientated in a further direction;
wherein each deflecting blade member comprises a respective deflection surface that deflects falling aggregate that impacts the deflection surface in an at least partially transverse direction.

45. The apparatus according to claim 44, which comprises at least one first deflecting member comprising the first plurality of deflecting blade members; and at least one further deflecting member comprising the further plurality of deflecting blade members.

46. The apparatus according to claim 44, wherein the first and further pluralities of deflecting blade members each comprise a respective plurality of elongate blade members disposed in a spaced apart substantially parallel relationship.

47. The apparatus according to claim 45, wherein the first and further pluralities of deflecting blade members are disposed in a vertically spaced apart substantially parallel relationship.

48. The apparatus according to claim 44, wherein the further plurality of deflecting blade members is a second plurality of deflecting blade members and the apparatus further comprises a third plurality of deflecting blade members, wherein the third plurality of deflecting blade members comprises a plurality of elongate blade members disposed in a vertically spaced apart substantially parallel relationship to the first plurality of deflecting blade members and the second plurality of deflecting blade members, wherein each deflecting blade member of the third plurality of deflecting blade members comprises a respective deflection surface that deflects falling aggregate that impacts the deflection surface in an at least partially transverse direction.

49. The apparatus according to claim 48, wherein the third plurality of deflecting blade members is disposed beneath the second plurality of deflecting blade members.

50. The apparatus according to claim 49, wherein each blade member of the third plurality of deflecting blade members is substantially parallel to a respective blade member of the first plurality of deflecting blade members.

51. The apparatus according to claim 49, wherein each blade member of the third plurality of deflecting blade members is disposed at a respective third blade location and each blade member of the first plurality of deflecting blade members is disposed at a respective first blade location, wherein each of the first locations is at least partially offset with respect to a respective third location.

52. The apparatus according to claim 51, wherein each of the first locations is at least partially offset in a transverse direction with respect to a respective one of the third locations.

53. The apparatus according to claim 44, which further comprises a tapered section disposed at a lower portion thereof and at least one mesh layer disposed beneath the first and further plurality of deflecting blade members.

54. The apparatus according to claim 53, wherein the at least one mesh layer comprises a plurality of spaced apart, substantially parallel, mesh layers each comprising a plurality of openings wherein openings in the mesh layer are offset with respect to openings in an adjacent mesh layer.

55. The apparatus according to claim 44, which is adapted to comprise a substantially fluid-tight seal such that a negative pressure may be applied thereto, wherein the apparatus comprises a lid element disposed on an upper portion thereof, and wherein the lid element comprises a sealing member for sealing a housing to enable negative pressure to be applied to the apparatus.

56. The apparatus according to claim 44, wherein the target location is disposed in an enclosure, wherein in use the enclosure is disposed beneath the apparatus and wherein the apparatus is adapted for a sealing attachment to the enclosure, wherein said sealing attachment enables a negative pressure to be applied to the enclosure.

57. The apparatus according to claim 44, wherein the aggregate release device comprises a plurality of panels, wherein each panel is selectively rotatable about a respective longitudinal axis from a closed position in which edges of adjacent panels at least partially overlap, to an open position in which edges of the panels are spaced apart to allow the aggregate material to be released.

58. A method of distributing aggregate material at a target location, the method comprising re-directing a vertical downwards falling motion of at least a portion of aggregate material via a plurality of deflecting blade members, wherein the method comprises releasing aggregate material from a storage location and directing the aggregate material to a first plurality of deflecting blade members.

59. A method of forming a surface apparatus, the method comprising;
providing an apparatus according to claim 44;
positioning an enclosure containing a resin component and a curing agent below the apparatus;
releasing aggregate material substantially simultaneously from a storage location in a generally downward falling motion within the apparatus; and
distributing the aggregate material in the enclosure.

60. The method according to claim 59, which comprises connecting the apparatus to a negative pressure source and applying a negative pressure to the enclosure.

61. An assembly for manufacturing an apparatus that provides a surface and which comprises a resin component and an aggregate material, the assembly comprising:
an apparatus according to claim 44; and
a support for supporting an enclosure containing an activated resin component below the apparatus.

62. The assembly of claim 61, which comprises at least one motor for vibrating the apparatus and/or the support and wherein the assembly further comprises at least one further support for supporting the enclosure.

63. The assembly of claim 62, wherein the at least one further support comprises at least one transfer element for transferring the enclosure to the further support and wherein the at least one transfer element comprises a roller.
